(19) United States
(12) Patent Application Publication
(10) Pub. No.: US 2014/0046967 A1
(43) Pub. Date: Feb. 13, 2014

(54) SYSTEM AND METHOD FOR PATTERN RECOGNITION AND ANALYSIS

(71) Applicants: Jim Nash-Walker, Nashua, NH (US); Greg Borton, Tiburon, CA (US)

(72) Inventors: Jim Nash-Walker, Nashua, NH (US); Greg Borton, Tiburon, CA (US)

(73) Assignee: Listening Methods, LLC, Tiburon, CA (US)

(21) Appl. No.: 13/989,025

(22) PCT Filed: Nov. 22, 2011
(86) PCT No.: PCT/US11/61903

§ 371 Date: Nov. 1, 2013

Related U.S. Application Data
(60) Provisional application No. 61/416,164, filed on Nov. 22, 2010.

(51) Int. Cl. G06F 17/30

(52) U.S. Cl. CPC G06F 17/30386
USPC 707/754; 707/780

(57) ABSTRACT

Apparatus and methods are described herein for recognizing repeated patterns in audio data. An audio input is compared to search terms to determine whether a match can be found. Repeated machine-generated audio presented in telephone calls that support Integrated Voice Response (IVR) applications are identified and used to analyze the performance of IVR systems.

### CLAIM OF PRIORITY UNDER 35 U.S.C. §119

The present Application for Patent claims priority to Provisional Patent Application No. 61/416,164 entitled “Frequency-Based Analog Pattern Recognition” filed Nov. 22, 2010, the entirety of which is expressly incorporated by reference herein.

### BACKGROUND

1. Field

This invention relates generally to analog signal pattern recognition, and more specifically to identifying matches in analog signals and analyzing the data, such as in an automated response telephone system.

2. Background

Identifying repeated analog frequency patterns within larger analog data streams is a difficult process. Technology may be used to find and describe the repeated patterns themselves, or to identify unexpected analog noise that does not match such patterns. One example of a system wherein identifying repeated analog frequency patterns is an automated response telephone system.

In automated voice response telephone systems, it is expensive and difficult to capture and identify activities of callers with the system's integrated voice response (IVR) solutions. Typical IVR systems generate audio to greet a caller, ask questions of the caller, and navigate the caller through a range of call options. A call may be transferred to a call center agent, and may again be transferred to other automated voice solutions for additional services. Most typical IVR systems use recorded prompts that are presented repeatedly to callers, as appropriate. In many cases, each prompt is an independent IVR application.

Companies spend considerable amounts of money on IVR analytics in an attempt to determine the effectiveness of the IVR system. One problem is that independent analytical tools must be applied for each individual IVR application, which is difficult and costly to do. It would therefore be desirable to have a system and method for automatically capturing end-to-end call actions in a self-service IVR system for analysis.

### SUMMARY

The following presents a simplified summary of one or more aspects of the present invention in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with some aspects of the present invention, a method for performing pattern matching comprises receiving, as a first input, electronically encoded analog input data to be matched; receiving as a second input, a plurality of electronically encoded analog search term; converting the first input into a first set of data elements having frequency and time components; generating one or more search term segments for each analog search term from the second input; and comparing the frequency and time components of the first input with at least one of the search term segments for one or more of the plurality of electronic analog search terms in a step-wise matter to determine if a potential match exists.

In accordance with some aspects of the present invention, a pattern matching apparatus comprises a receiver configured to receive, as a first input, electronically encoded analog input data to be matched and to receive, as a second input, a plurality of electronically encoded analog search terms; and a sound analysis module configured to convert the first input into a first set of data elements having frequency and time components, generate one or more search term segments for each analog search term from the second input, and compare the frequency and time components of the first input with at least one of the search term segments for one or more of the plurality of electronic analog search terms in a step-wise manner to determine if a potential match exists.

To the accomplishment of the foregoing and related ends, the one or more aspects of the present invention comprise the features hereinafter fully described and particularly pointed out in the claims. The following description and the annexed drawings set forth in detail certain illustrative features of the one or more aspects of the present invention. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an exemplary automated response telephone system in accordance with an aspect of the present invention;

FIG. 2 illustrates an example analytics server for use with an automated response telephone system in accordance with an aspect of the present invention;

FIG. 3 illustrates an example flowchart of a method for performing pattern matching in accordance with an aspect of the present invention;

FIG. 4 illustrates an example data point mapping that may be generated in accordance with an aspect of the present invention;

FIGS. 5A-5C illustrate examples of filters that select frequency values in input and/or search term data in accordance with an aspect of the present invention;

FIG. 6 illustrates an example of segmented analog search term data in accordance with an aspect of the present invention;

FIG. 7 illustrates an example time-bases stepping process for searching for a match in accordance with an aspect of the present invention;

FIG. 8 illustrates an example confirming a tentative match in accordance with an aspect of the present invention;

FIG. 9 illustrates an example of a matching process where there may be noise present in the input source data in accordance with an aspect of the present invention;

FIG. 10 illustrates an example match that starts in the middle of the search term in accordance with an aspect of the present invention;

FIG. 11 illustrates an example set of data that may be output in accordance with an aspect of the present invention;

FIG. 12 illustrates various features of an example computer system for use in conjunction with aspects of the present invention; and

FIG. 13 illustrates an exemplary system diagram of various hardware components and other features for use in accordance with aspects of the present invention.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Various aspects or features will be presented in terms of systems that may include a number of devices, components, modules, and the like. It is to be understood and appreciated that the various systems may include additional devices, components, modules, etc. and/or may not include all of the devices, components, modules etc., discussed in connection with the figures. A combination of these approaches may also be used.

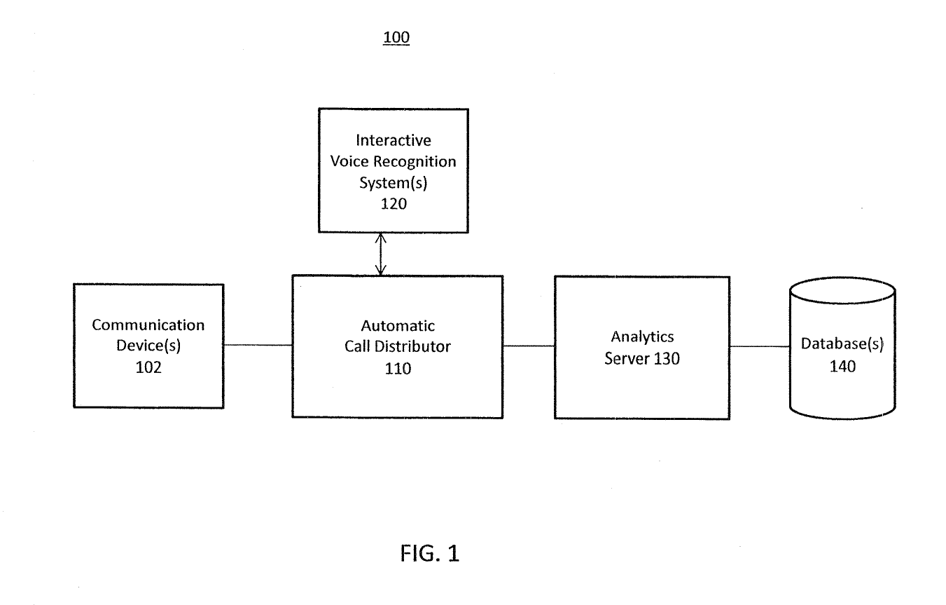

FIG. 1 depicts an exemplary automated response telephone system 100 that may implement various disclosed aspects. One or more communication devices 102 may connect to an automatic call distributor (ACD) telephone system 110. Communications devices 102 may include, for example, a landline telephone, a mobile cellular/wireless telephone, and/or any other telephonic communication device. ACD telephone system 110 may be coupled to one or more IVR systems 120, and an analytics server 130 that is in turn, coupled to one or more databases 140. ACD telephone system 110 may be configured to route calls to one or more terminals. ACD telephone system 110 uses one or more IVR systems 120, which provides prompts to users, to route calls to the appropriate destination.

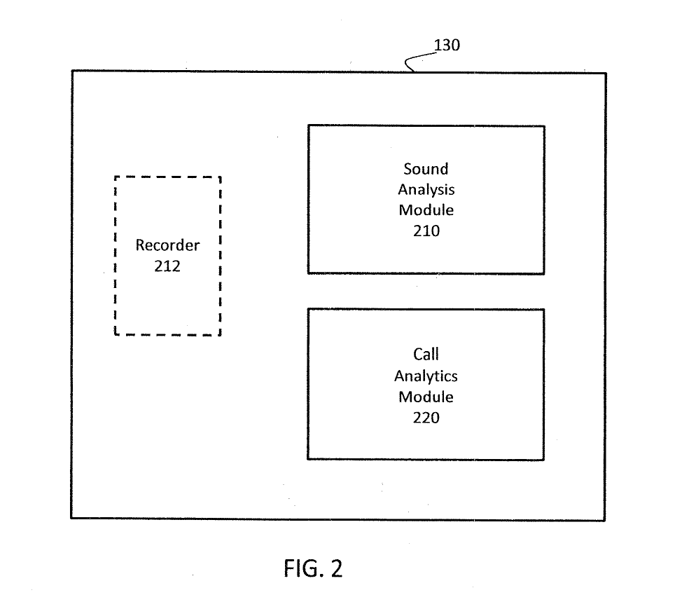

Analytics server 130 may be configured to record or to obtain recordings or live caller interactions with IVR systems 120, and may be further configured to provide analysis reports indicating the effectiveness of the IVR system. FIG. 2 illustrates analytics server 130 in greater detail. Analytics server 130 may include a sound analysis module 210 and a call analytics module 220. Sound analysis module 210 may be configured to receive an input data source, which may be received from recorder 212. For example, the input data may be audio of a call interfacing with IVR 120. The input data may include, for example, a mono, stereo, or dual channel recording of a call to a telephone system; recordings of broadcasts, streaming audio, or streaming video; real-time audio from sources including mono, stereo, or dual channel audio from telephone systems, broadcasts or microphones; analog data from live or recorded data sources, provided by microphones, pressure gauges, security systems, or other analog signal detection device, and/or any other analog input data. Recorded input data may be stored in one or more databases 140 shown in FIG. 1. While shown as a component of analytics server 130, recorder 212 may be an external device that records sound data and provides the recorded data to sound analysis module 210. Sound analysis module may also receive as input one or more analog search terms from a data source, such as one or more databases 140 depicted in FIG. 1.

Referring again to FIG. 2, sound analysis module 210 may be configured to perform a plurality of functions on its inputs, including a frequency and data format transformation process, a filtering process, and a windowing process. Sound analysis module 210 may output a plurality of data elements representing the data extracted and analyzed from the input data stream to call system analysis module 220. Call system analysis module 220 may then generate a plurality of reports that indicate the effectiveness of the call system.

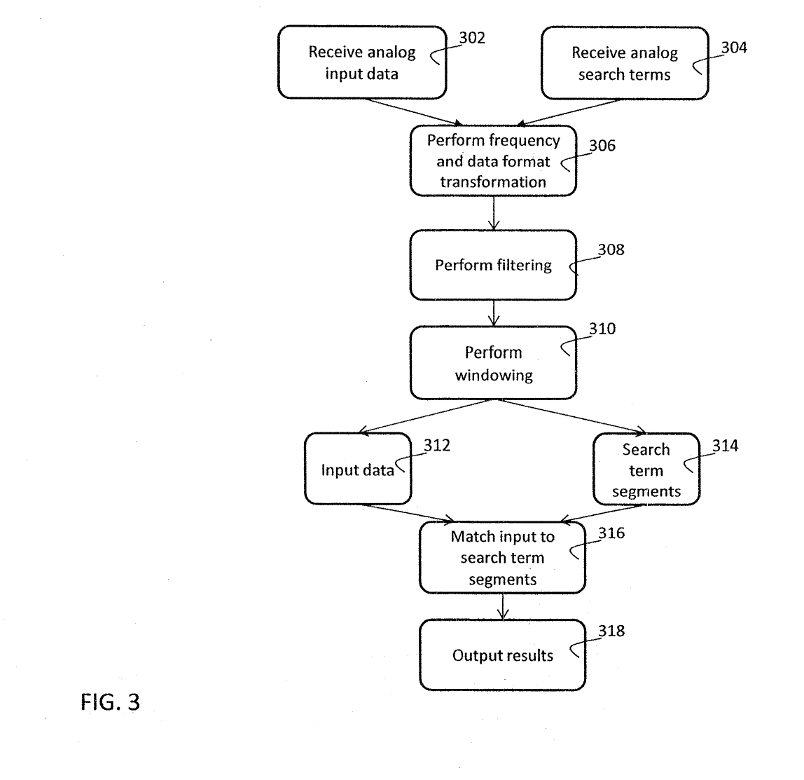

FIG. 3 is a flowchart showing a sound analysis process that may be implemented, for example, by sound analysis module 201, to provide frequency-based pattern matching. As shown at 302, electronically encoded analog input data may be received. For example, in an automated response telephone system, the input data may be telephone calls that have been recorded. The recorded date, in its electronic format, may comprise a .wav file, an .mp3 file, and/or any other electronic format. In some aspects, the recording data may be stored in or more directories, available locally at analysis server 130 or accessible via a computer network. In other aspects, rather than receiving recorded data as an input, a stream of data coming from a real-time or live analog data source, such as an active phone call, may be provided as input. As shown at 304, electronically encoded analog search terms may also be received. The analog search terms may be used for searching the analog input data to find an instance of the analog search term, and to determine what portion of the search term is represented in the analog input. The search terms may be, for example, IVR prompts detected from previous phone calls that have been stored in a data base. In some aspect, the search terms may include other data, for example, the identification of distinct speakers, the capture of dual tone multi-frequency (DTMF) codes, and/or other events.

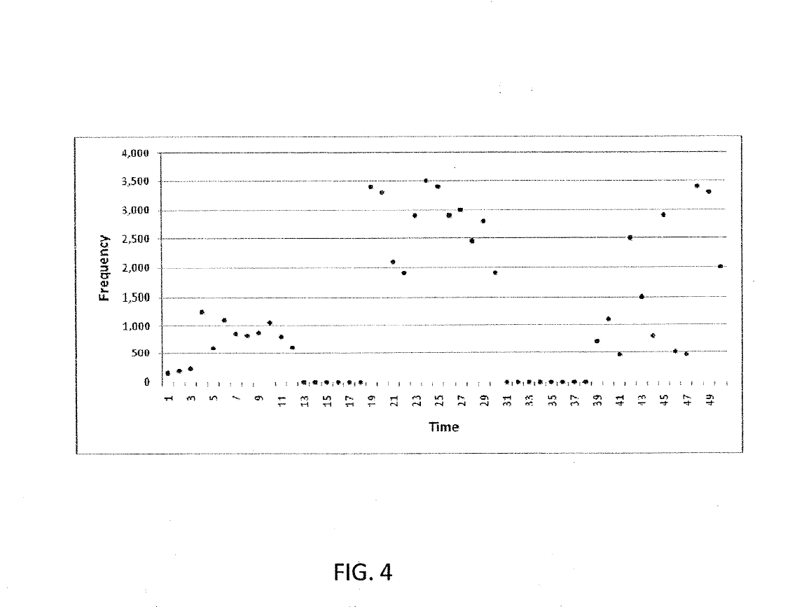

As shown at 306, the received analog input data and the analog search terms may undergo a frequency and data format transformation process. The transformation process converts the source data from its encoded format into a format compatible with the analysis system, and transforms the data into a set of frequency and time data points. The transformation process may include, for example, transforming the data from an analog format to a digital format and/or performing one or more Fourier transformations, fast Fourier transforms, wavelet algorithms, and/or any other transformation algorithm on the data. As an example, source data may be available in a very high resolution, such as 20,000 data elements per second, whereas the analysis system may only require 400 data elements per second. A similar situation may apply to frequency. For example, the source data frequency range may be quite large, while the analysis system may only require a smaller frequency range. The transformation process normalizes source data into the desired number of data points, converting the analog input and search term data into the appropriate number of data elements. FIG. 4 is an example data point mapping that may be generated after the input data has been frequency and time transformed. Transforming the input data and/or search term segments may include varying the time and/or frequency axes of the respective input, enabling a later determination of whether a match exists across different time scales. In some aspects, transforming the inputs may include transforming the data to account for interruptions in either time or frequency.

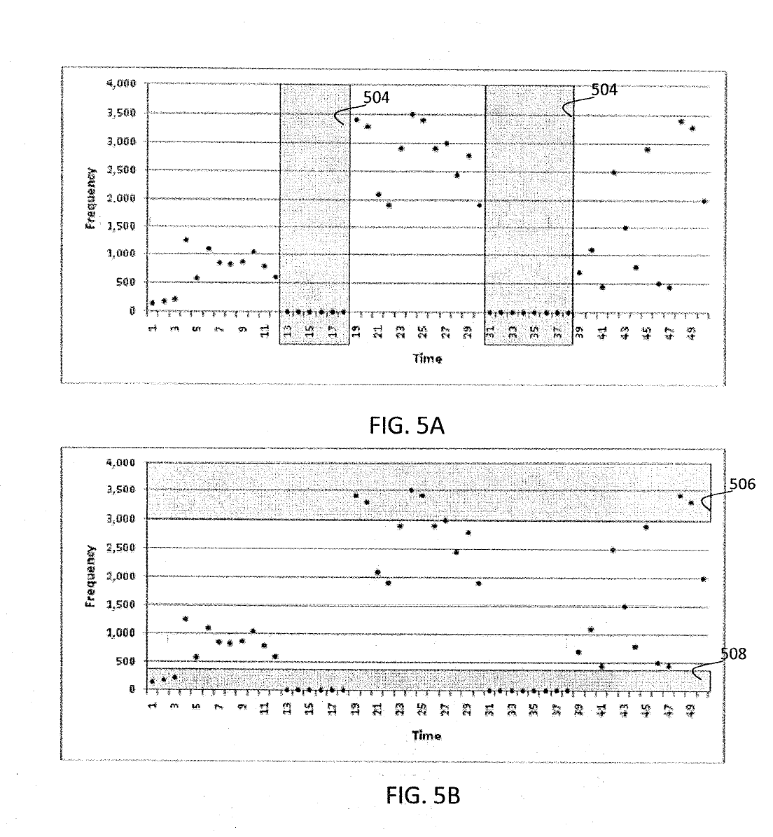

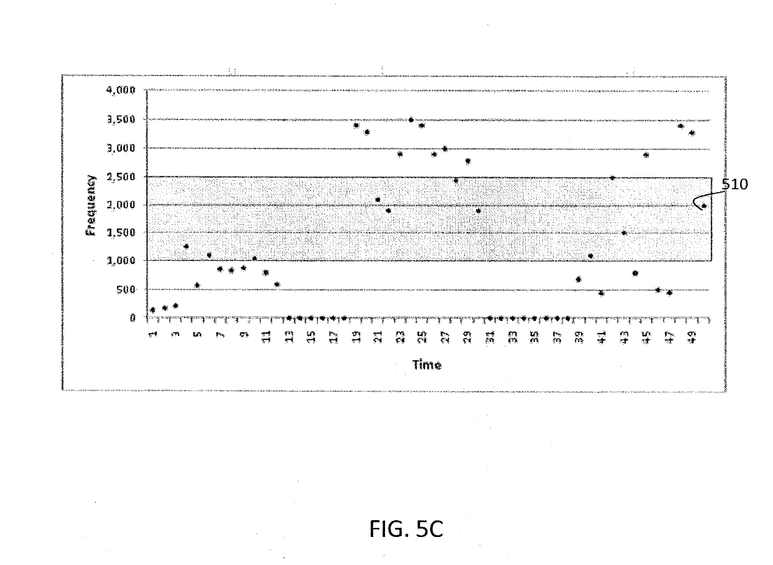

Returning to FIG. 3, the converted data may then undergo a filtering process, as shown at 308. The filtering process removes any data points that are not needed for the matching process. Filtering may be used, for example, to make it less difficult to detect a match between an input data source and one or more search terms. The filtering process may remove data based on its value (e.g., null values), frequency, timing, etc. For example, one particular implementation of the analysis system may need only certain frequencies to be analyzed. The filtering process may select the desired frequency points from the data, removing the non-significant frequency data. The filtering process may also include adding data for selected time periods, data with selected amplitude and/or frequency attributes, and/or merging/de-merging data elements into a desired number of data elements based on frequency and/or time. One or more types of filtering may be applied to a data input. FIGS. 5A, 5B, and 5C illustrate examples of filters that select frequency values in input and/or search term data. In FIG. 5A, filtering is performed by detecting data points having null (zero) frequency values, as shown at 502 and 504. In the example shown in FIG. 5B, high and low frequency components are removed, as shown at 506 and 508. In the example shown in FIG. 5C, mid-range frequencies are removed, as shown at 510.

Returning again to FIG. 3, search term data that has been transformed and/or filtered, as needed, may undergo a windowing process, as shown at 310. The windowing process may divide the analog search term data into smaller search term segments. Each segment may include any number of data points, based on implementation. Segments may be windowed on a time and/or frequency basis. That is, a search term may be broken into a plurality of time segments and/or into a plurality of frequency segments. Frequency windowing enables removal of frequency data that is not relevant to the search term, resulting in an increase match rate.

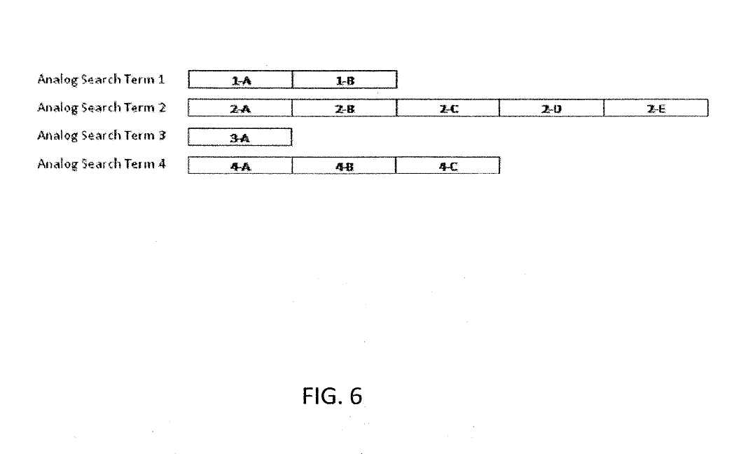

FIG. 6 is an example of segmented analog search term data. As shown in FIG. 6, analog search term 1 comprises two segments, search term 2 comprises four segments, search term 3 comprises a single segment, and search term 4 comprises three segments. In this particular example, the segments represent time segments, though frequency segments may also be used.

Referring again to FIG. 3, as shown at 312 and 314, input data segments and a set of search term data segments are provided following the windowing process. A matching process may then be implemented, as shown at 316. For example, the matching process may retrieve a search term segment and compare it to the input source data by stepping through the input source data one step at a time. The stepping process may include any type of stepping pattern such as, for example, sequential time-based steps through the input data, steps that jump forwards or backwards though the input data based on time or frequency characteristics, steps that jump forwards or backwards through the input data based on amplitude data, steps that are modified based on results of previous steps, etc. In each step, the matching process compares the frequency data in the search term segment with that in the input data source. A potential match is indicated if a number of matching frequency data points in the search term and the input data source meets or exceeds a defined threshold. If a step is not a match, the matching process may then move to the next step and perform the comparison again. In some aspects, the windowing process may modify the duration of the time segments. For example, the duration of the time segments may be set using feedback from the matching process and the results indicating what segment duration and/or frequency yields the best results.

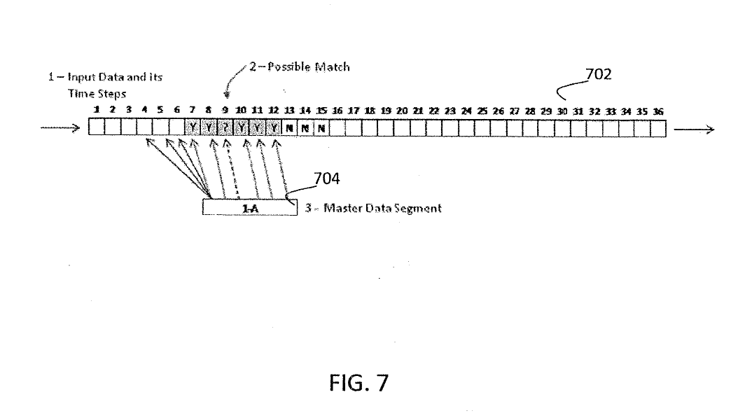

FIG. 7 illustrates an example time-bases stepping process for searching for a match. As shown at 702, an input data stream has been transformed into a plurality of time steps. A first search term segment 704 of a search term is compared to the input data stream time steps. First search term segment 704 has a plurality of time slots, and each time slot is progressively compared to the time steps in the input data. In this example, matches have been found in slots 7, 8, 10, 11, and 12, and a possible match has been found at slot 9. If the number of matches meets or exceeds a defined threshold, then the identified section of the input data may be considered a potential match with the search term.

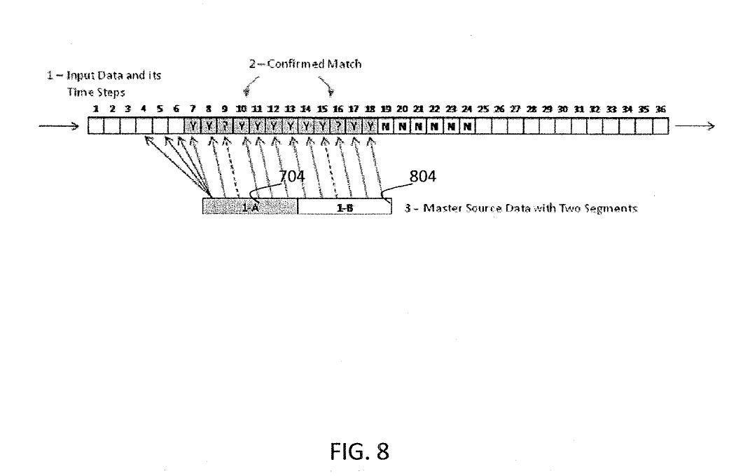

According to some aspects, upon finding a potential match, additional search term segments of a search term may be checked to confirm whether a match exists. FIG. 8 shows an example of confirming a tentative match. Data in input data stream 702 is tentatively a match for first search term segment 704, as shown FIG. 7. As shown in FIG. 8, second search term segment 804 may be compared to the next set of steps in the input data to determine whether it is a match in the same manner used for first search term segment 704. In some aspects, verification may be performed relative to input data steps occurring before the tentatively matching segment. If second term segment 804 is also a match, then a determination may be made that the input source data does contain the desired search term. While only one confirmation check is shown in FIG. 8, additional confirmation checks may be performed before concluding that the input data source contains a search term. In some aspects, where multiple confirmation checks are performed, a determination of a match may be made when all checks indicate a match. In other aspects, a determination of a match is made when the number of confirmation checks indicating a match meets or exceeds a defined threshold.

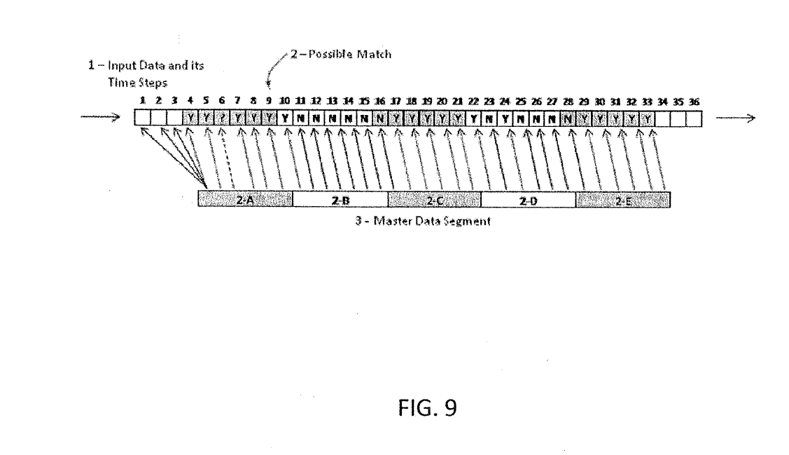

FIG. 9 is an example of a matching process in which there may be noise present in the input source data. Here, the confirmation process walks across many segments, some of which are matches and others are not. The algorithms evaluating the match would determine whether the matches are adequate to conclude that there is a true match between the search term and the input data.

Upon determining that a search term is present in an input data stream, a determination may be made as to the duration of the match with the search term. For example, in an IVR system, a search term may be a prompt offered to a caller by the IVR. The prompt, however, may be interrupted during its presentation to the caller as a result of the caller requesting an agent (at which point the integrated voice response solution interrupts the playing of the prompt and begins the transfer process to the agent) or the result of a hang-up on the part of the caller. In this case, the matching process may be looking for the last search term segment which is also present in the input source data. The identity of this search term segment may then be used to determine how much of the search term was actually present in the input source data.

Noise or other factors may affect the presence of the initial search term segment in a search term. Again, using an IVR system as an example, the IVR may begin playing a prompt from the beginning, but electrical noise may block the initial information that would have been found by several of the search term segments when evaluating the input source data. Under these circumstances, the matching process may be configured to detect that the search term is present, but that the first match with the search term is in the middle of the search term's segments. This enables a user of the data output to decide whether to report the start time of the prompt as the beginning of the prompt or the actual time in the search term when the matching process detected a match with the prompt.

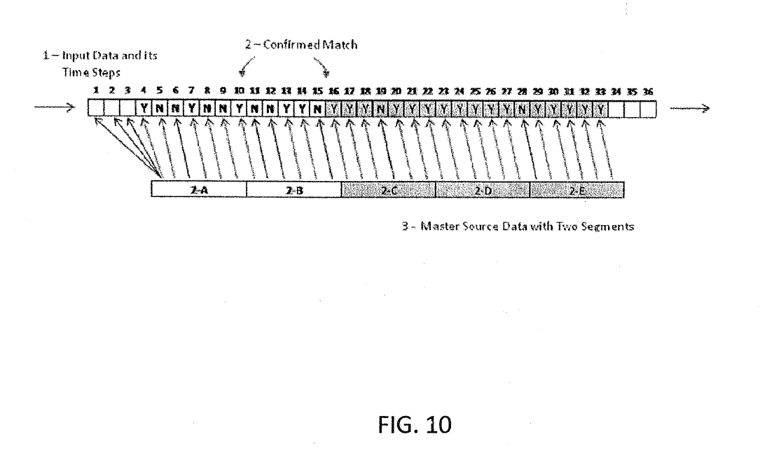

FIG. 10 illustrates an example match that starts in the middle of the search term. Here, either noise has prevented matches between the first search term segment and the input data, or the input data does not have any data that might match until later in the search term.

Each time a match process searches the input audio for another search term segment, it may apply a set of rules to determine how the input audio should be searched. For example, it may make a separate pass (the stepping process) through the entire input audio, step by step based on each next unit of time, for each search term segment. This pass may be modified by secondary considerations, such as using a stepping process that is searching for a confirming match at a specific position in the input audio. It may use other methods for determining how to step through the input audio, for example, based on changes in frequencies, i.e., start the search when a certain frequency is discovered, etc.

The match process may also be configured to manage the capture of other data, such as, for example, noise events (i.e., portions of the input audio that meet specified criteria for frequencies or variations in frequencies, duration, or amplitude but that do not match any search terms). Noise events may have meaning in particular situations, as much meaning as matches of search terms. If, for instance, there are two search term matches in an audio signal and a noise event between these two, this may indicate that there is a new event that should be captured and classified as an additional search term.

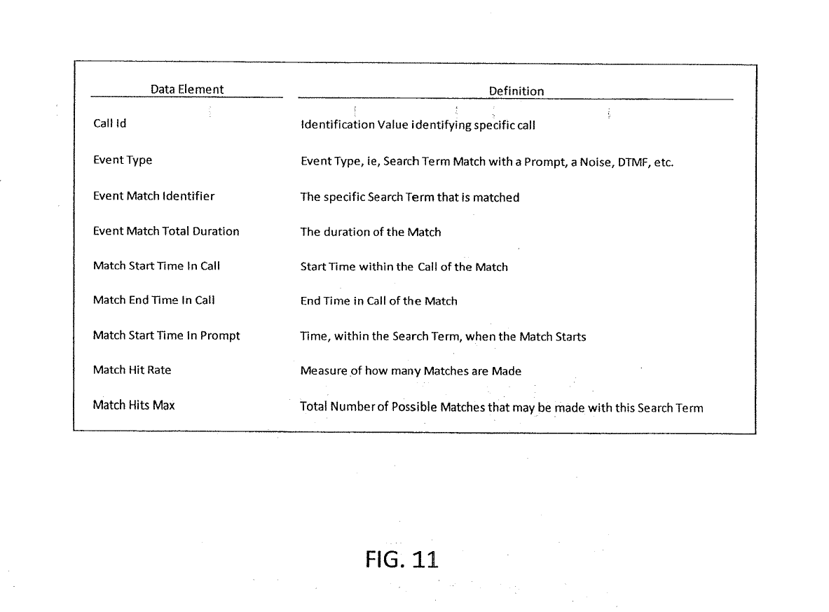

Returning once again to FIG. 3, as shown at 318, data may be output from the matching process to a log, database, application programming interface (API) etc., for presenting and analyzing the results of the matching process. The output may comprise, for example, data elements describing matches, the time and possible duration of matches, noise events, DTMF codes, and/or other data. FIG. 11 presents an example of one set of data that may be output.

As described above in reference to FIG. 2, a call analytics module 220 may also be provided for analyzing the data output by sound analysis module 210. Results may be presented, for example, as a set of reports, an interactive “dashboard” showing the results, etc. The results may provide an indication of how well the IVR systems work. For example, using the data obtained by sound analysis module 210, call analytics module 220 may provide reports indicating whether callers follow the desired path through IVR prompts, whether callers hang-up often and as a result of certain prompts, the callers' willingness to engage with the IVR system, etc. In automated response telephone systems, opt-outs refer to the case where a call is routed from the IVR system to an agent. According to one aspect, the call analytics module 220 may present results indicating how many planned and/or unplanned opt-outs occur as a result of particular IVR prompts.

While the examples described herein are applied to automated telephone response and IVR systems, the methods and apparatus described herein are equally applicable to any situation wherein the identification of repeated sounds would be beneficial. For example, other applications may include monitoring the health of large mechanical systems, in manufacturing plants, and mining operations or transportation conveyances, among other applications. A set of microphones may be used to capture audio, including frequencies significantly outside those heard by people. “Healthy” audio signals may be classified such that they are excluded from analysis, while “unidentified noise” events may indicate a problem with the mechanical system.

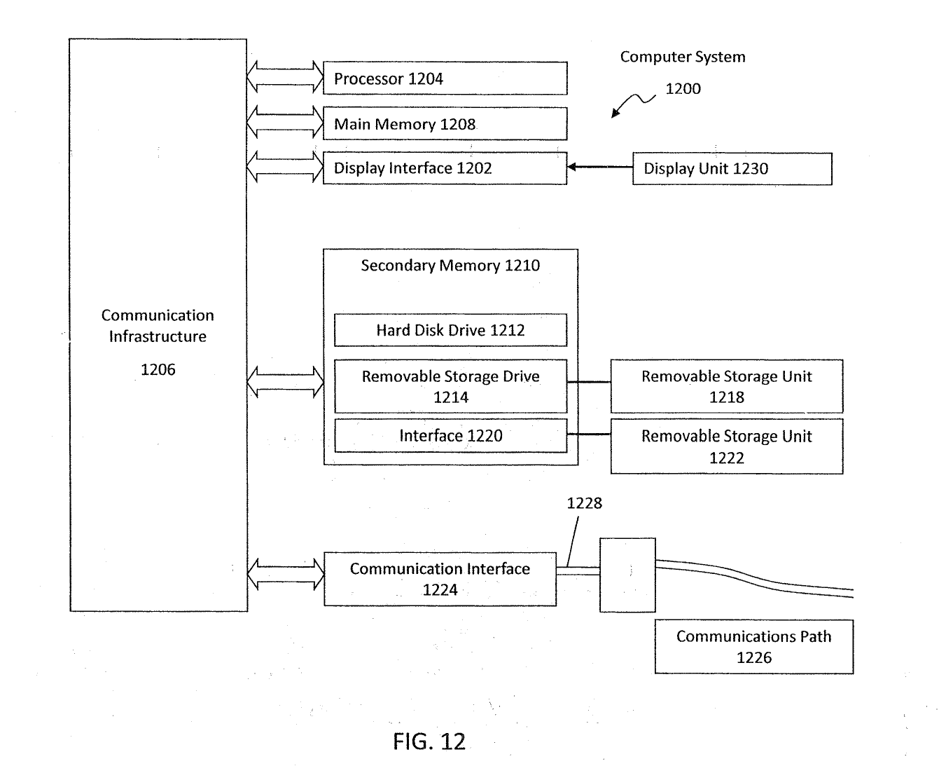

Aspects disclosed herein may be implemented using a combination of hardware, software and firmware in a computer system. In one aspect, one or more computer systems may carry out the functionality described herein. An example of such a computer system 1200 is shown in FIG. 12.

Computer system 1200 includes one or more processors, such as processor 1204. The processor 1204 is connected to a communication infrastructure 1206 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 1200 can include a display interface 1202 that forwards graphics, text, and other data from the communication infrastructure 1206 (or from a frame buffer not shown) for display on a display unit 1230. Computer system 1200 also includes a main memory 1208, preferably random access memory (RAM), and may also include a secondary memory 1210. The secondary memory 1210 may include, for example, a hard disk drive 1212 and/or a removable storage drive 1214, representing a floppy disk drive, a magnetic tape drive, an optical disk drive, etc. The removable storage drive 1214 reads from and/or writes to a removable storage unit 1218 in a well-known manner. Removable storage unit 1218, represents a floppy disk, magnetic tape, optical disk, etc., which is read by and written to removable storage drive 1214. As will be appreciated, the removable storage unit 1218 includes a computer usable storage medium having stored therein computer software and/or data.

Alternative aspects of the present invention may include secondary memory 1210 and may include other similar devices for allowing computer programs or other instructions to be loaded into computer system 1200. Such devices may include, for example, a removable storage unit 1222 and an interface 1220. Examples of such may include a program cartridge and cartridge interface (such as that found in video game devices), a removable memory chip (such as an erasable programmable read only memory (EPROM), or programmable read only memory (PROM)) and associated socket, and other removable storage units 1222 and interfaces 1220, which allow software and data to be transferred from the removable storage unit 1222 to computer system 1200.

Computer system 1200 may also include a communications interface 1224. Communications interface 1224 allows software and data to be transferred between computer system 1200 and external devices. Examples of communications interface 1224 may include a modem, a network interface (such as an Ethernet card), a communications port, a Personal Computer Memory Card International Association (PCMCIA) slot and card, etc. Software and data transferred via communications interface 1224 are in the form of signals 1228, which may be electronic, electromagnetic, optical or other signals capable of being received by communications interface 1224. These signals 1228 are provided to communications interface 1224 via a communications path (e.g., channel) 1226. This path 1226 carries signals 1228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 1280, a hard disk installed in hard disk drive 1270, and signals 1228. These computer program products provide software to the computer system 1200. The invention is directed to such computer program products.

Computer programs (also referred to as computer control logic) are stored in main memory 1208 and/or secondary memory 1210. Computer programs may also be received via communications interface 1224. Such computer programs, when executed, enable the computer system 1200 to perform the features of the present invention, as discussed herein. In particular, the computer programs, when executed, enable the processor 1210 to perform the features of the present invention. Accordingly, such computer programs represent controllers of the computer system 1200.

In an aspect of the present invention where the invention is implemented using software, the software may be stored in a computer program product and loaded into computer system 1200 using removable storage drive 1214, hard drive 1212, or communications interface 1220. The control logic (software), when executed by the processor 1204, causes the processor 1204 to perform the functions of the invention as described herein. In another aspect of the present invention, the invention is implemented primarily in hardware using, for example, hardware components, such as application specific integrated circuits (ASICs). Implementation of the hardware state machine so as to perform the functions described herein will be apparent to persons skilled in the relevant art(s).

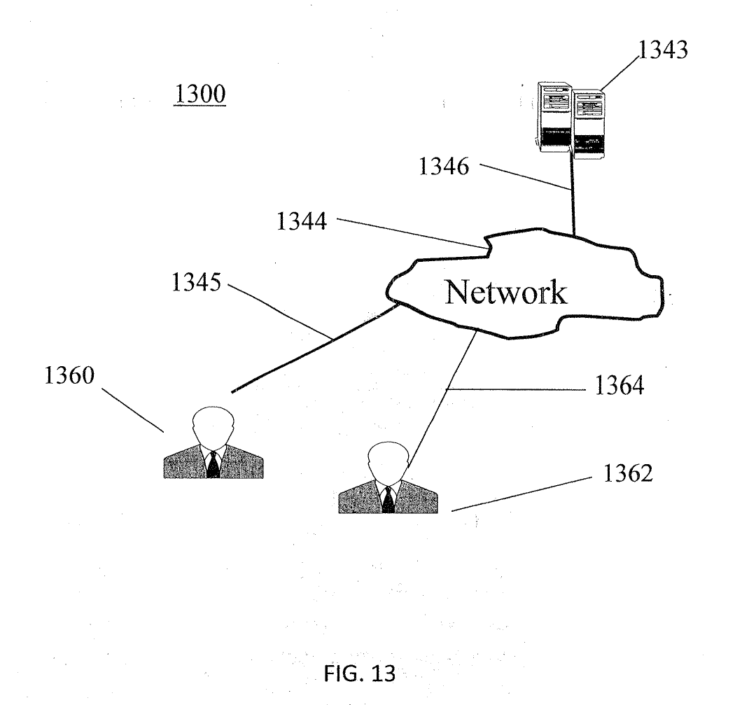

FIG. 13 shows a communication system 1300 usable in accordance with the present invention. The communication system 1300 includes one or more accessors 1360, 1362 (also referred to interchangeably herein as one or more “users”) and one or more terminals 1342, 1366. In one aspect, data for use in accordance with the present invention is, for example, input and/or accessed by accessors 1360, 1362 via terminals 1342, 1366, such as personal computers (PCs), minicomputers, mainframe computers, microcomputers, telephonic devices, or wireless devices, such as personal digital assistants (“PDAs”) or a hand-held wireless devices coupled to a server 1343, such as a PC, minicomputer, mainframe computer, microcomputer, or other device having a processor and a repository for data and/or connection to a repository for data, via, for example, a network 1344, such as the Internet or an intranet, and couplings 1345, 1364, 1346. The couplings 1345, 1346, 1364 include, for example, wired, wireless, or fiberoptic links. In another aspect, the method and system of the present invention operate in a stand-alone environment, such as on a single terminal.

While the foregoing disclosure discusses illustrative aspects of the present application, it should be noted that various changes and modifications could be made herein without departing from the scope of the described aspects as defined by the appended claims. Furthermore, although elements of the described aspects may be described or claimed in the singular, the plural is contemplated unless limitation to the singular is explicitly stated. Additionally, all or a portion of any aspect may be utilized with all or a portion of any other aspect and/or variation, unless stated otherwise.

1. A method for performing pattern matching, comprising:
receiving, as a first input, electronically encoded analog input data to be matched;
receiving, as a second input, a plurality of electronically encoded analog search terms;
converting the first input into a first set of data elements having frequency and time components;
generating one or more search term segments for each analog search term from the second input; and
comparing the frequency and time components of the first input with at least one of the search term segments for one or more of the plurality of electronic analog search terms in a step-wise manner to determine if a potential match exists.

2. The method of claim 1, further comprising:
filtering at least one of the first input and the second input to remove unwanted components prior to comparing.

3. The method of claim 2, wherein the filtering comprises removing null values.

4. The method of claim 2, wherein the filtering comprises removing one or more frequency components.

5. The method of claim 1, further comprising:
upon determining that a potential match exists based on a first search term segment of a search term, comparing one or more additional segments of the search term to the first input to confirm whether a match exists.

6. The method of claim 1, further comprising:
outputting one or more indicators describing an identified match between the first input and one or more search terms of the second input upon determining that a match has been found.

7. The method of claim 1, wherein the first input comprises one of a recording of a call to a telephone system or real-time audio of a call to a telephone system, and wherein the analog search terms comprise prompts extracted from an interactive voice response system.

8. The method of claim 1, wherein the first input comprises a set of discrete events, each discrete event having a unique identifier.

9. The method of claim 1, wherein converting the first input into a first set of data elements having frequency and time components comprises performing one or more of a Fourier transform and a Fast Fourier transform.

10. The method of claim 1, wherein the one or more search term segments comprise time-based segments.

11. The method of claim 1, wherein the matching process is further configured to vary one or more of duration, frequency, order, or timing of data in the search segments.

12. A pattern matching apparatus, comprising:
a receiver configured to receive, as a first input, electronically encoded analog input data to be matched and to receive, as a second input, a plurality of electronically encoded analog search terms; and
a sound analysis module configured to convert the first input into a first set of data elements having frequency and time components, generate one or more search term segments for each analog search term from the second input, and compare the frequency and time components of the first input with at least one of the search term segments for one or more of the plurality of electronic analog search terms in a step-wise manner to determine if a potential match exists.

13. The pattern matching apparatus of claim 12, wherein the sound analysis module is further configured to filter at least one of the first input and the second input to remove unwanted components prior to comparing.

14. The pattern matching apparatus of claim 12, wherein the sound analysis module is further configured to, upon determining that a potential match exists based on a first search term segment of a search term, compare one or more additional segments of the search term to the first input to confirm whether a match exists.

15. The pattern matching apparatus of claim 12, wherein the sound analysis module is further configured to output one or more indicators describing an identified match between the first input and one or more search terms of the second input upon determining that a match has been found.

16. The pattern matching apparatus of claim 12, wherein the first input comprises one of a recording of a call to a telephone system or real-time audio of a call to a telephone system, and wherein the analog search terms comprise prompts extracted from an interactive voice response system.

17. The pattern matching apparatus of claim 12, wherein the first input comprises a set of discrete events, each discrete event having a unique identifier.

18. The pattern matching apparatus of claim 12, wherein the sound analysis module is configured to convert the first input into a first set of data elements having frequency and time components by performing a Fourier transform or a Fast Fourier transform.

19. The pattern matching apparatus of claim 12, wherein the one or more search term segments comprise time-based segments.

20. The pattern matching apparatus of claim 12, wherein the sound analysis module is further configured to vary one or more of duration, frequency, order, or timing of data in the search segments.

21. A computer program product comprising a computer usable medium having control logic stored therein for causing a computer to perform pattern matching, the control logic comprising:
means for receiving, as a first input, electronically encoded analog input data to be matched;
means for receiving, as a second input, a plurality of electronically encoded analog search terms;
means for converting the first input into a first set of data elements having frequency and time components;
means for generating one or more search term segments for each analog search term from the second input; and
means for comparing the frequency and time components of the first input with at least one of the search term segments for one or more of the plurality of electronic analog search terms in a step-wise manner to determine if a potential match exists.
